(19) United States
(12) Patent Application Publication
(10) Pub. No.: US 2013/0093839 A1
(43) Pub. Date: Apr. 18, 2013

(54) APPARATUS AND METHOD OF GENERATING THREE-DIMENSIONAL (3D) PANORAMIC IMAGE

(71) Applicants: Young Sun JEON, Yongin-si (KR); Young Su MOON, Seoul (KR); Shi Hwa LEE, Seoul (KR); Joon Hyuk CHA, Incheon (KR)

(72) Inventors: Young Sun JEON, Yongin-si (KR); Young Su MOON, Seoul (KR); Shi Hwa LEE, Seoul (KR); Joon Hyuk CHA, Incheon (KR)

(73) Assignee: Samsung Electronics Co., Ltd., Suwon-si (KR)

(21) Appl. No.: 13/587,583

(22) Filed: Aug. 16, 2012

(30) Foreign Application Priority Data
Oct. 12, 2011 (KR) 10-2011-0104135

(51) Int. Cl. H04N 13/02; H04N 7/00

(52) U.S. Cl. 348/36; 348/46; 348/E07.001; 348/E13.074

(57) ABSTRACT

An apparatus and method of generating a three-dimensional (3D) panoramic image, using a single camera. The apparatus may include a frame slit capturing unit to capture a first frame slit in an Nth video frame, and to capture a second frame slit from an (N+2)th video frame, and a 3D image generating unit to generate a left image using the captured first frame slit and the captured second frame slit. Here, the frame slit capturing unit may capture a third frame slit in an (N+1)th video frame, and captures a fourth frame slit in an (N+3)th video frame, and the 3D image generating unit may generate a right image using the captured third frame slit and the captured fourth frame slit.

### CROSS-REFERENCE TO RELATED APPLICATIONS

This application claims the priority benefit of Korean Patent Application No. 10-2011-0104135, filed on Oct. 12, 2011, in the Korean Intellectual Property Office, the disclosure of which is incorporated herein by reference.

### BACKGROUND

1. Field

Example embodiments relate to an apparatus and method of generating a three-dimensional (3D) panoramic image using a single camera, and more particularly, to a technical spirit for generating a 3D panoramic image using a conventional two-dimensional (2D) camera, without transforming hardware for 3D photography, such as, a 3D lens or a stereo system.

2. Description of the Related Art

The demand for 3D display devices, for example, 3D TVs, is increasing in accordance with the rapid development of digital technology.

The 3D display device provides 3D image content, that is, an image has an appearance of being in 3D space.

A method of reproducing a real 3D image is being used to generate the 3D image content. However, a method that is widely studied and applied corresponds to a technology for generating a disparity between both eyes by presenting, to a left eye and a right eye, images identical to scenes viewed from left and right directions, respectively, and synthesizing and providing the images to be viewed as if the images are a single 3D image.

The 3D image content may be generated from a two-dimensional (2D) image by applying stereoscopy to both eyes. Also, in general, images photographed using at least two cameras are required to create the 3D image content.

For ease of reference, stereoscopy refers to a technique for creating, in a 2D image, information that may be acquired additionally, and enabling a human to experience dynamism and sense of reality as if the human is in a place where images are being produced, through the created additional information.

### SUMMARY

The foregoing and/or other aspects are achieved by providing an apparatus for generating a three-dimensional (3D) panoramic image, the apparatus including a frame slit capturing unit to capture a first frame slit in an Nth video frame, and to capture a second frame slit from an (N+2)th video frame, and a 3D image generating unit to generate a left image using the captured first frame slit and the captured second frame slit. Here, the frame slit capturing unit may capture a third frame slit in an (N+1)th video frame, and may capture a fourth frame slit in an (N+3)th video frame. The 3D image generating unit may generate a right image using the captured third frame slit and the captured fourth frame slit.

The frame slit capturing unit may capture the first frame slit, the second frame slit, the third frame slit, and the fourth frame slit by projecting a plurality of photographed video frames using a spherical coordinate system.

The frame slit capturing unit may calculate a gap between the first frame slit and the third frame slit, and may determine a gap between the second frame slit and the fourth frame slit to be identical to the gap calculated between the first frame silt and the third frame slit.

The frame slit capturing unit may determine a viewpoint for capturing the second frame slit so that the second slit may be continuous with the first frame slit, and may determine a viewpoint for capturing the fourth frame slit so that the fourth frame slit may be continuous with the third frame slit.

The foregoing and/or other aspects are also achieved by providing an apparatus for generating a 3D panoramic image, the apparatus including a left image generating unit to generate a left image by capturing at least one left frame slit in a 2Nth video frame, a right image generating unit to generate a right image by capturing at least one right frame slit in a (2N−1)th video frame, and a 3D image generating unit to generate a 3D panoramic image based on the generated left image and the generated right image.

The left image generating unit may calculate a gap between the at least one left frame slit, and the right image generating unit may determine a gap between the at least one right frame slit to be identical to the gap calculated between the at least one left frame slit.

The left image generating unit may determine a viewpoint for capturing the at least one left frame slit so that the at least one left frame slit may be continuous in the left image, and the right image generating unit may determine a viewpoint for capturing the at least one right frame slit so that the at least one right frame slit may be continuous in the right image.

The foregoing and/or other aspects are also achieved by providing a method of generating a 3D panoramic image, the method including capturing, by a frame slit capturing unit, a first frame slit in an Nth video frame, capturing, by the frame slit capturing unit, a third frame slit in an (N+1)th video frame, capturing, by the frame slit capturing unit, a second frame slit from an (N+2)th video frame, capturing, by the frame slit capturing unit, a fourth frame slit in an (N+3)th video frame, generating, by a 3D image generating unit, a left image using the captured first frame slit and the captured second framed slit, and generating, by the 3D image generating unit, a right image using the captured third frame slit and the captured fourth frame slit.

The method may further include calculating a gap between the first frame slit and the third frame slit, and determining a gap between the second frame slit and the fourth frame slit to be identical to the gap calculated between the first frame silt and the third frame slit, by the frame slit capturing unit. Here, the second frame slit and the fourth frame slit may be captured, by the frame slit capturing unit, based on the gap determined between the second frame slit and the fourth frame slit.

The capturing of the second frame slit may include determining, by the frame slit capturing unit, a viewpoint for capturing the second frame slit so that the second slit may be continuous with the first frame slit, and the capturing of the fourth frame slit may include determining, by the frame slit capturing unit, a viewpoint for capturing the fourth frame slit so that the fourth frame slit may be continuous with the third frame slit.

According to example embodiments, left and right 3D images corresponding to a 3D panoramic image may be generated using a single camera including a single lens and a single sensor.

According to example embodiments, a 3D panoramic image may be generated rapidly and accurately, using images collected using a camera included in a mobile phone, having a characteristic of a low-frame rate.

According to example embodiments, a frame slit may be applied easily at a low-frame rate since the frame slit may be generated using left and right slits that are relatively greater than a conventional slit.

According to example embodiments, a 3D panoramic image may be generated using any commercialized image sensor.

According to example embodiments, a ghost image generated when images are matched or stitched may be processed more easily since a greater slit width is used when the images are matched, when compared to a conventional technique.

According to example embodiments, an amount of calculation may be reduced since a number of portions to be matched between images may be reduced and a number of times for blending may be reduced as well, for an image of an identical view, that is, the same size.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an apparatus for generating a three-dimensional (3D) panoramic image, according to example embodiments;

FIG. 2 illustrates photographing of a subject from a plurality of viewpoints, according to example embodiments;

FIG. 3 illustrates a case in which an image photographed in FIG. 2 is projected using a spherical coordinate system;

FIG. 4 illustrates a frame sequence for each time, in a form of a top view, according to example embodiments;

FIG. 5 illustrates an apparatus for generating a 3D panoramic image, according to other example embodiments; and

FIG. 6 illustrates a method of generating a 3D panoramic image, according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

When it is determined that a detailed description is related to a known function or configuration, which may make the purpose of the present disclosure unnecessarily ambiguous in the description, such detailed description will be omitted. Additionally, terminologies used herein are defined to appropriately describe the exemplary embodiments, and thus, may be changed depending on a user, the intent of an operator, or a custom. Accordingly, the terminologies must be defined based on the following overall description of this specification.

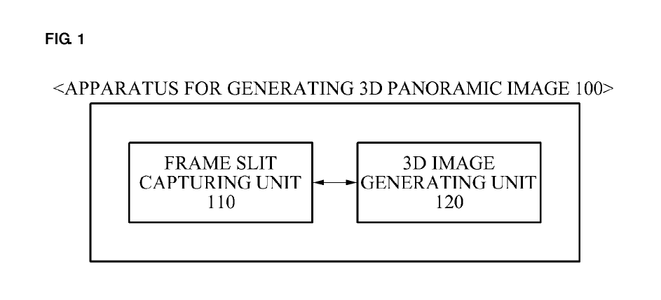

FIG. 1 illustrates an apparatus for generating a three-dimensional (3D) panoramic image, according to example embodiments.

An apparatus 100 for generating a 3D panoramic image may use left and right viewpoint images by selecting a temporal image on a temporal axis.

That is, the apparatus 100 may generate left and right panoramic images using different images that are a predetermined distance apart from each other on a temporal axis, in a spatial point of view, instead of using left and right panoramic images in a single image, thereby enabling a 3D image to be viewed using a 3D display device, such as a 3D TV.

The apparatus 100 may be fundamentally used to generate a panoramic image using multiple frames having continuous and overlapped portions.

For example, the apparatus 100 may be applied to devices, such as, a digital still camera (DSC), a digital video camera (DVC), a surveillance camera, a mobile camera, and a smart phone. In addition, the apparatus 100 may be used as a camera sensor image signal processor.

According to example embodiments, the apparatus 100 may include a frame slit capturing unit 110, and a 3D image generating unit 120.

The frame slit capturing unit 110 may capture a first frame slit in an Nth video frame, and may capture a second frame slit in an (N+2)th video frame.

The 3D image generating unit 120 may generate a left image using the captured first frame slit and the captured second frame slit.

The frame slit capturing unit 110 may capture a third frame slit in an (N+1)th video frame, and may capture a fourth frame slit in an (N+3)th video frame. The 3D image generating unit 120 may generate a right image using the captured third frame and the captured fourth frame.

That is, the apparatus 100 may generate left and right 3D images corresponding to a 3D panoramic image, using a single camera including a single lens and a single sensor.

According to example embodiments, a 3D panoramic image may be generated rapidly and accurately, using images collected using a camera included in a mobile phone, having a characteristic of a low-frame rate.

According to example embodiments, a frame slit may be applied easily at a low-frame rate since the frame slit may be generated using left and right slits that are relatively greater than a conventional slit.

According to example embodiments, a 3D panoramic image may be generated using any commercialized image sensor.

According to example embodiments, a ghost image generated when images are matched or stitched may be processed more easily, since a greater slit width is used when the images are matched, when compared to a conventional technique.

According to example embodiments, an amount of calculation may be reduced since a number of portions to be matched between images may be reduced and a number of times for blending may be reduced as well, for an image of an identical view, that is, the same size.

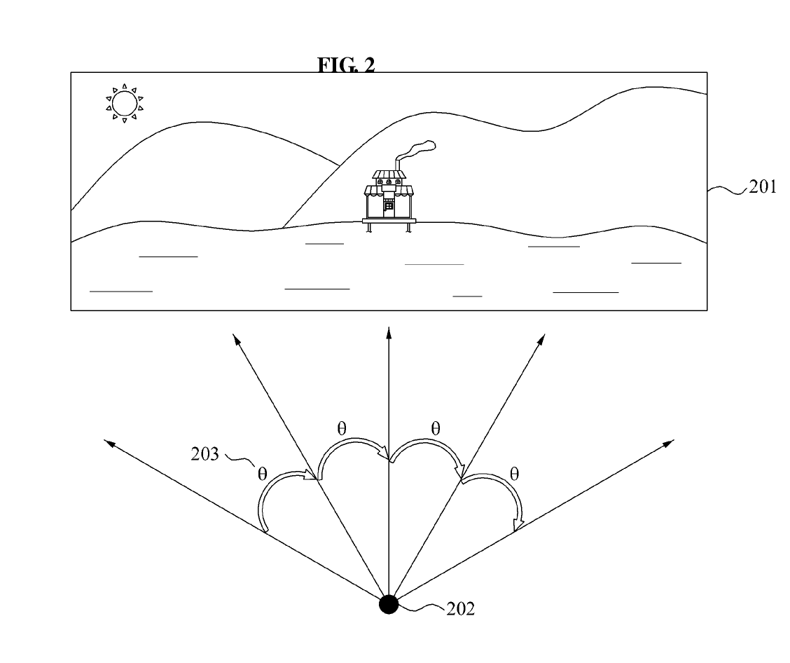

FIG. 2 illustrates photographing a subject from a plurality of viewpoints, according to example embodiments.

The apparatus 100 of FIG. 1 may be applied, in a modular form, a portable terminal device including a camera module, for example, a mobile terminal, and the like.

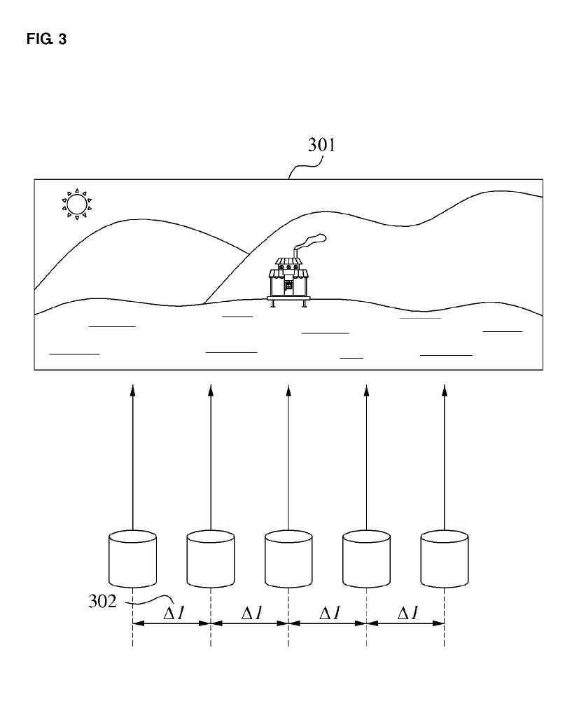

Example embodiments in which a video frame input into the apparatus 100 may be photographed using the portable terminal device will be described with reference to FIGS. 2 and 3.

The portable terminal device may generate a plurality of video frames using a camera 202 that photographs a subject 201 from a plurality of viewpoints.

The camera 202 located at a fixed location may rotate and generate a plurality of images of the subject 201, having overlapped portions.

That is, the camera 202 may photograph the subject 201 from the plurality of viewpoints generated, based on the rotation at the fixed location.

Herein, the rotation may be construed as an operation generated when a user moves, rather than an operation generated by predetermined hardware used for moving the camera 202.

Accordingly, additional hardware for the rotation of the camera 202 may be unnecessary.

Continuous viewpoints for capturing, among a plurality of viewpoints for capturing, may correspond to viewpoints generated when the camera 202 rotates by an angle 203 of θ, and some of a plurality of video frames that are captured from the continuous viewpoints for capturing may be overlapped.

The portable terminal device may control the camera 202 to capture the subject 201 by determining instances when the camera 202 rotates by the angle 203 of θ to be viewpoints for capturing the subject.

Each of the viewpoints for capturing may be classified based on an angle of rotation of a predetermined size, i.e., ‘θ’.

That is, the plurality of video frames, captured from different viewpoints that are different from each other by the angle of ‘θ’, may be processed to be frame slits used to generate a left image and a right image, in order to be processed to be a 3D panoramic image.

For example, a frame slit captured in a first video frame may be included in a left image, and a frame slit captured in a second video frame may be included in a right image.

FIG. 3 illustrates a case in which an image photographed in FIG. 2 is projected using a spherical coordinate system.

According to example embodiments, a frame slit capturing unit may capture the first frame slit, the second frame slit, the third frame slit, and the fourth frame slit by projecting the plurality of photographed video frames using a spherical coordinate system.

The image photographed by rotating the camera 202 by a predetermined angle 203, based on the fixed location as a center, as illustrated in FIG. 2, may be represented, in the spherical coordinate system, to be photographed when the camera moves a predetermined distance.

In other words, since a difference between video frames captured from a plurality of viewpoints when the camera 202 rotates by an angle 203, and video frames captured when the camera 202 moves in a horizontal direction may be insignificant, it will be described that the video frames captured when the camera 202 rotates and the video frames captured when the camera 202 horizontally moves may be determined to be identical.

That is, the camera 202 may recognize a viewpoint 302 moved by ‘Δ/’ as a viewpoint for capturing a subject, and may photograph a subject 301. Video frames captured in the foregoing manner may be almost identical, excluding portions of edges.

Accordingly, a 3D panoramic image may be generated using a single camera 202 as illustrated in FIG. 2, and through a rotational movement of the camera 202 only, without changing a location of the camera 202.

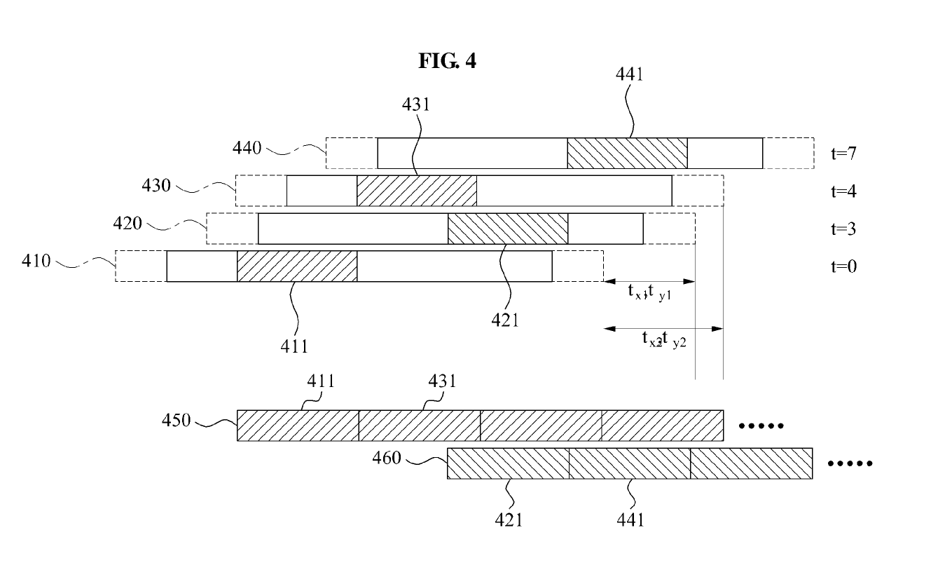

FIG. 4 illustrates a frame sequence for each time, in a form of a top view, according to example embodiments.

The captured video frames may be classified, for each time, into a first video frame 410, a second video frame 420, a third video frame 430, and a fourth video frame 440.

In a conventional method, left and right viewpoint images may be extracted from each of the captured video frames. However, according to example embodiments, frame slits 411 and 431 to be used for a left image 450 may be captured in the first video frame 410 and the third video frame 430, and frame slits 421 and 441 to be used for a right image 460 may be captured in the second video frame 420 and the fourth video frame 440.

The captured frame slits 411 and 431 may be used for the left image 450, and the captured frame slits 421 and 441 may be used for the right image 460.

According to example embodiments, a frame slit capturing unit may calculate a gap between the first frame slit 411 and the third frame slit 431, and may determine a gap between the second frame slit 421 and the fourth frame slit 441 to be identical to the gap calculated between the first frame slit 411 and the third frame slit 431.

Additionally, the frame slit capturing unit may determine a viewpoint for capturing the second frame slit 421 so that the second slit 421 may be continuous with the first frame slit 411, and may determine a viewpoint for capturing the fourth frame slit 441 so that the fourth frame slit 441 may be continuous with the third frame slit 431.

In a conventional technique, left and right viewpoint images may be used in a single video frame. However, according to example embodiments, left and right viewpoint video frames may be used by selecting a temporal image on a temporal axis.

That is, according to the conventional technique, a baseline length of a stereo image may be determined, based on a gap between image slits, corresponding to left and right images that are captured in a single video frame. However, according to example embodiments, the baseline length may be determined using a distance between the left and right images, according to a temporal gap for acquiring the left and right images.

When a 3D panoramic image is generated using a slit width image of a small size by applying the conventional technique at a low-frame rate, image matching may not be performed well, and thus, the images should be photographed slowly to generate the 3D panoramic image.

According to example embodiments, an amount of calculation necessary may be reduced, since a number of portions to be matched between images may be reduced, and a number of times for blending may be reduced, as well, for an image of an identical view, i.e., the same size.

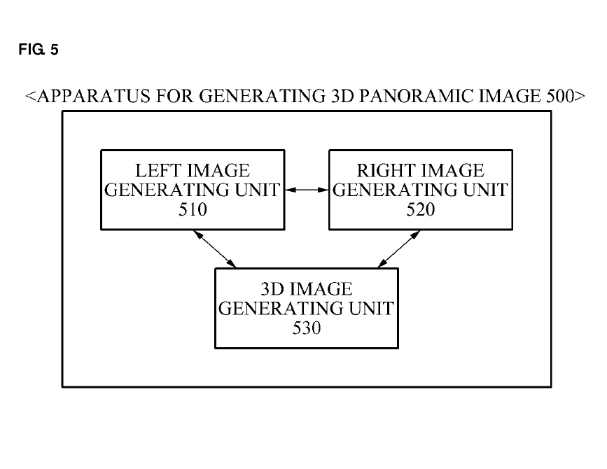

FIG. 5 illustrates an apparatus for generating a 3D panoramic image, according to other example embodiments.

According to other example embodiments, an apparatus 500 for generating a 3D panoramic image may include a left image generating unit 510, a right image generating unit 520, and a 3D image generating unit 530.

The left image generating unit 510 may generate a left image by capturing at least one left frame slit in a 2Nth video frame.

The left image generating unit 510 may calculate a gap between the at least one left frame slit.

The right image generating unit 520 may generate a right image by capturing at least one right frame slit in a (2N−1)th video frame.

The right image generating unit 520 may determine a gap between the at least one right frame slit to be identical to the gap calculated between the at least one left frame slit.

For example, when the left image generating unit 510 captures frame slits in an order of a second video frame, a fourth video frame, and a sixth video game, the right image generating unit 520 may capture frame slits in an order of a first video frame, a third video frame, and a fifth video frame.

That is, the apparatus 500 may capture one of frame slits for the left image and frame slits for the right image in a single video frame.

The 3D image generating unit 530 may generate a 3D panoramic image based on the generated left image and the generated right image.

The apparatus 500 may generate left and right panoramic images using different images that are a predetermined distance apart from each other on a temporal axis, in a spatial point of view, instead of using left and right panoramic images in a single image.

Left and right images of two viewpoints may be used for an input image of a general 3DTV, which has recently come into wide use. The left and right images of two viewpoints may be generated to be viewed using the 3DTV, using a single camera including a single camera lens and a single camera sensor, corresponding to a general type of camera owned by a majority of camera users, without using a camera having two camera lenses.

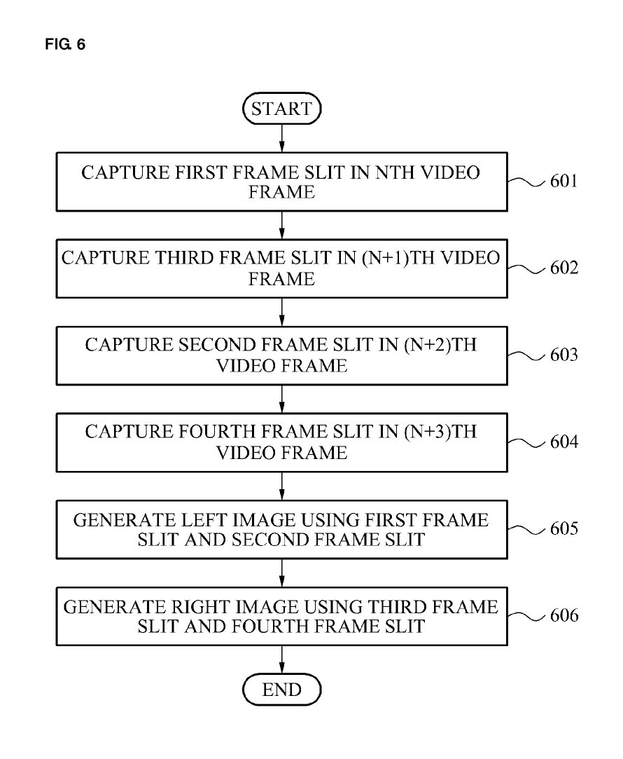

FIG. 6 illustrates a method of generating a 3D panoramic image, according to example embodiments.

In the method according to example embodiments, a first frame slit may be captured in an Nth video frame in operation 601, and a third frame slit may be captured in a continuous (N+1)th video frame in operation 602, by a frame slit capturing unit.

A second frame slit may be captured in an (N+2)th video frame in operation 603, and a fourth frame slit may be captured in a continuous (N+3)th video frame in operation 604, by the frame slit capturing unit.

In operation 605, a left image may be generated using the captured first frame slit and the second frame slit, by a 3D image generating unit.

In operation 606, a right image may be generated using the captured third frame slit and the captured fourth frame slit, by the 3D image generating unit.

When the method of generating the 3D panoramic image, according to example embodiments is used, a frame slit may be applied easily at a low-frame rate since the frame slit may be generated using left and right slits that are relatively greater than a conventional slit. Accordingly, a 3D panoramic image may be generated using any commercialized image sensors.

The method of generating the 3D panoramic image according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. The described hardware devices may be configured to act as one or more software modules in order to perform the operations of the above-described embodiments, or vice versa.

Further, according to an aspect of the embodiments, any combinations of the described features, functions and/or operations can be provided.

Moreover, the apparatus for generating a 3D panoramic image, as shown in FIG. 1, for example, may include at least one processor to execute at least one of the above-described units and methods.

According to example embodiments, a frame slit may be applied easily at a low-frame rate since the frame slit may be generated using left and right slits that are relatively greater than a conventional slit.

According to example embodiments, a 3D panoramic image may be generated using any commercialized image sensor.

According to example embodiments, a ghost image generated when images are matched or stitched may be processed more easily since a greater slit width is used when the images are matched, when compared to a conventional technique.

According to example embodiments, an amount of calculation may be reduced since a number of portions to be matched between images may be reduced and a number of times for blending may be reduced as well, for an image of an identical view, that is, the same size.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for generating a three-dimensional (3D) panoramic image, the apparatus comprising:
a frame slit capturing unit to capture a first frame slit in an Nth video frame, and to capture a second frame slit from an (N+2)th video frame; and
a 3D image generating unit to generate a left image using the captured first frame slit and the captured second frame slit, wherein the frame slit capturing unit captures a third frame slit in an (N+1)th video frame, and captures a fourth frame slit in an (N+3)th video frame, and the 3D image generating unit generates a right image using the captured third frame slit and the captured fourth frame slit.

2. The apparatus of claim 1, wherein the frame slit capturing unit captures the first frame slit, the second frame slit, the third frame slit, and the fourth frame slit by projecting a plurality of photographed video frames using a spherical coordinate system.

3. The apparatus of claim 1, wherein the frame slit capturing unit calculates a gap between the first frame slit and the third frame slit, and determines a gap between the second frame slit and the fourth frame slit to be identical to the gap calculated between the first frame silt and the third frame slit.

4. The apparatus of claim 1, wherein the frame slit capturing unit determines a viewpoint for capturing the second frame slit, such that the second slit is continuous with the first frame slit, and determines a viewpoint for capturing the fourth frame slit, such that the fourth frame slit is continuous with the third frame slit.

5. The apparatus of claim 1, wherein the left image and the right image are generated to be viewed using a 3D television, using a single camera lens and a single camera sensor.

6. An apparatus for generating a three-dimensional (3D) panoramic image, the apparatus comprising:
a left image generating unit to generate a left image by capturing at least one left frame slit in a 2Nth video frame;
a right image generating unit to generate a right image by capturing at least one right frame slit in a (2N−1)th video frame; and
a 3D image generating unit to generate a 3D panoramic image based on the generated left image and the generated right image.

7. The apparatus of claim 6, wherein the left and right generating units capture the left and right frame slits by projecting a plurality of photographed video frames using a spherical coordinate system.

8. The apparatus of claim 6, wherein
the left image generating unit calculates a gap between the at least one left frame slit, and
the right image generating unit determines a gap between the at least one right frame slit to be identical to the gap calculated between the at least one left frame slit.

9. The apparatus of claim 6, wherein
the left image generating unit determines a viewpoint for capturing the at least one left frame slit, such that the at least one left frame slit is continuous in the left image, and
the right image generating unit determines a viewpoint for capturing the at least one right frame slit, such that the at least one right frame slit is continuous in the right image.

10. The apparatus of claim 6, wherein the left image and the right image are generated to be viewed using a 3D television, using a single camera lens and a single camera sensor.

11. A method of generating a three-dimensional (3D) panoramic image, the method comprising:
capturing, by a frame slit capturing unit, a first frame slit in an Nth video frame;
capturing, by the frame slit capturing unit, a third frame slit in an (N+1)th video frame;
capturing, by the frame slit capturing unit, a second frame slit from an (N+2)th video frame;
capturing, by the frame slit capturing unit, a fourth frame slit in an (N+3)th video frame;
generating, by a 3D image generating unit, a left image using the captured first frame slit and the captured second framed slit; and
generating, by the 3D image generating unit, a right image using the captured third frame slit and the captured fourth frame slit.

12. The method of claim 11, wherein the frame slit capturing unit captures the first frame slit, the second frame slit, the third frame slit, and the fourth frame slit by projecting a plurality of photographed video frames using a spherical coordinate system.

13. The method of claim 11, further comprising:
calculating a gap between the first frame slit and the third frame slit, and determining a gap between the second frame slit and the fourth frame slit to be identical to the gap calculated between the first frame silt and the third frame slit, by the frame slit capturing unit, wherein the second frame slit and the fourth frame slit are captured, by the frame slit capturing unit, based on the gap determined between the second frame slit and the fourth frame slit.

14. The method of claim 11, wherein
the capturing of the second frame slit comprises determining, by the frame slit capturing unit, a viewpoint for capturing the second frame slit, such that the second slit is continuous with the first frame slit, and
the capturing of the fourth frame slit comprises determining, by the frame slit capturing unit, a viewpoint for capturing the fourth frame slit, such that the fourth frame slit may be continuous with the third frame slit.

15. A non-transitory computer-readable medium comprising a program for instructing a computer to perform the method of claim 11.

16. The method of claim 11, wherein the left image and the right image are generated to be viewed using a 3D television, using a single camera lens and a single camera sensor.
